(19) United States
(12) Patent Application Publication
(10) Pub. No.: US 2012/0093994 A1
(43) Pub. Date: Apr. 19, 2012

(54) Meat Analog Compositions and Process

(75) Inventors: Fu-hung Hsieh, Columbia, MO (US); Harold E. Huff, Ashland, MO (US)

(73) Assignee: The Curators of the University of Missouri, Columbia, MO (US)

(21) Appl. No.: 13/272,825

(22) Filed: Oct. 13, 2011

Related U.S. Application Data
(60) Provisional application No. 61/392,838, filed on Oct. 13, 2010.

(51) Int. Cl. A23L 1/31; A23J 1/09; A23J 1/00; A23J 1/20

(52) U.S. Cl. 426/549; 426/656; 426/580; 426/583; 426/614; 426/657; 426/574

(57) ABSTRACT

Analog meat compositions produced from vegetable protein and processes for producing the analog meat compositions are described. The compositions are produced with high moisture content, low vegetable protein content, carbohydrate, and, optionally, an edible lipid material and provides a product that simulates the fibrous structure of animal meat and has a desirable meat-like moisture, texture, mouthfeel, flavor and color.

### CROSS REFERENCE TO RELATED APPLICATIONS

The present application is a non-provisional application claiming the benefit of U.S. Provisional Patent Application Ser. No. 61/392,838, filed Oct. 13, 2010, which is incorporated herein by reference in its entirety.

### FIELD OF THE INVENTION

The subject matter disclosed herein relates to meat analog compositions produced from vegetable protein, and processes for producing the meat analog compositions. The composition and process may be used to provide high quality, fibrous meat analog compositions similar to chicken, fish or other meats of animal origin in appearance and mouthfeel. The products can be further processed into ready-to-eat, refrigerated, frozen, canned, dehydrated, and fried protein foods. The meat analog compositions tend to retain more flavor than traditional texturized vegetable proteins, particularly texturized vegetable proteins produced by extrusion at high moisture conditions.

### BACKGROUND OF THE INVENTION

Proteins are an essential element in human nutrition. Meat, in the form of animal flesh, and fish are the most common sources of high protein food. However, often the high cost of meat products prohibits people from buying them and, thus, makes them unavailable to many people in the world. Meat products may also be prone to spoiling. In addition, there are people who either do not eat meat or prefer to eat less meat for health or religious reasons. Vegetable proteins, therefore, play an important role in meeting recommended daily dietary requirements for protein. Food scientists have devoted much time developing methods for preparing acceptable meat-like food applications, such as beef, pork, poultry, fish, and shellfish analogs, from a wide variety of plant proteins and blends of meats and plant proteins.

Among the many sources of vegetable proteins, soy protein is a major vegetable protein used to produce meat analogs due to its abundant availability and low cost. Also, in recent years, soy protein has received increasing attention due to medical discoveries regarding its potential role in preventing cardiovascular disease.

Vegetable proteins, including soy protein, are also viewed as a weapon against obesity, an epidemic health problem in the United States and other parts if the world. In order to reap the nutritional value and health benefits of soy proteins, a major challenge facing food technologists has been to produce soy protein products that are palatable and readily accepted by consumers without a significant reduction in nutritional value and health benefits.

To make vegetable proteins palatable, texturization into fibrous meat analogs through extrusion processing has been a major approach. Due to its versatility, high productivity, energy efficiency and low cost, extrusion processing is widely used in the modern food industry. Well-known applications include ready-to-eat breakfast cereals, baby foods, pet foods, confectionery products, and meat extenders. Extrusion processing is a multi-step and multifunctional operation, which leads to mixing, hydration, shear, homogenization, compression, deaeration, pasteurization or sterilization, stream alignment, shaping, expansion and/or fiber formation. Ultimately, the vegetable protein, typically introduced to the extruder in the form of a dry blend, is processed to form a fibrous material.

In a typical thermoplastic extrusion process, dry proteinaceous materials, typically in the form of defatted soy protein, are mixed with water, salts, and flavorings (for flavor and odor control), and then fed into an extruder. Under high temperature and low moisture (<30%) conditions, the product expands rapidly upon emerging from the extruder die. Before being used in or as an edible food application, such an extruded protein product must be rehydrated with water.

The rapid expansion associated with such conventional thermoplastic extrusion processes result in the extruded protein products having a spongy structure, which causes or at least contributes to these products tending to have poor flavor retention, poor moisture retention, and a lack of recognizable fibrous texture. As a result, to date, meat analogs made from high temperature, low moisture (<30%) conditions have had limited acceptance because they lack moisture, flavor retention, meat-like texture and mouthfeel. Even those meat analogs that are produced with meat-like fibrous texture may not retain the desired texture over time, upon rehydration or during normal cooking conditions. Rather, they are characterized as dry, spongy and chewy, largely due to the random, twisted nature of the protein fibers that are formed and inability of the extrudate to retain moisture. As a result, most meat analogs have been largely limited to use as extenders for ground, hamburger-type meats.

New developments in extrusion technology have focused on using twin screw extruders under high moisture (40-80%) conditions for texturizing vegetable proteins into fibrous meat alternatives. In the high moisture twin screw process, also known as “wet extrusion”, the raw materials, predominantly vegetable proteins such as soy protein, are mixed and fed into a twin-screw extruder, where a proper amount of water is dosed in and all ingredients are further blended and then melted by the thermo-mechanical action of the screws. The realignment of large protein molecules, the laminar flow, and the strong tendency of stratification within the extruder's long slit cooling die contribute to the formation of a fibrous structure. The resulting wet-extruded products tend to exhibit improved whole muscle meat-like visual appearance and improved palatability. Therefore, this extrusion technology shows promise for texturizing vegetable proteins to meet increasing consumer demands for healthy and tasty foods.

However, there is a still an unmet need for a meat analog composition that more closely simulates the fibrous structure of animal meat and has a more meat-like moisture, texture, mouthfeel, flavor and color. There is also an unmet need for a high quality meat analog composition that may be produced at lower cost, including a meat analog composition that may be produced with lower quantities of protein material.

### SUMMARY OF THE INVENTION

The present invention is directed to a structured plant protein product that has a moisture content that is at least about 50% by weight of the structured plant protein product and that comprises protein fibers that are substantially aligned. The protein fibers comprise (a) dry ingredients and (b) wet ingredients. The dry ingredients comprise: (i) protein component that comprises a plant-derived protein material, wherein the protein component is at an amount that is no more than about 90% by weight of the dry ingredients; (ii) a carbohydrate component at an amount that is in the range of about 2 to about 50% by weight of the dry ingredients; and (iii) a lipid component at an amount that is in the range of about 0.1 to about 5% by weight of the dry ingredients. The wet ingredients comprise water.

The present invention is also directed to a structured plant protein product that has a moisture content that at least about 50% by weight of the structure plant protein product and an average Warner-Bratzler shear force that is less than 60 g/mm² and that comprises protein fibers, wherein at least about 90% of the protein fibers are contiguous to each other at less than approximately a 45° angle when viewed in a horizontal plane. The protein fibers comprise (a) dry ingredients and (b) wet ingredients. The dry ingredients comprise: (i) a plant-derived protein material, wherein the plant-derived protein material is at an amount that is in the range of about 60 to about 80% by weight of the dry ingredients; (ii) a carbohydrate component at an amount that is in the range of about 10 to about 30% by weight of the dry ingredients, wherein the carbohydrate components comprises edible fiber material at an amount that is in the range of about 2 to about 8% by weight of the dry ingredients; and (iii) an plant-derived lipid material an at an amount that is in the range of about 1 to about 5% by weight of the dry ingredients. The wet ingredients comprise water.

Additionally, the present invention is directed to a process for making a structured plant protein product, which has a moisture content that is at least about 50% by weight of the structured plant protein product, and that comprises protein fibers that are substantially aligned. The process comprises extruding a mixture under conditions of elevated temperature and pressure to form the structured plant protein product, wherein the mixture comprises (a) dry ingredients and (b) wet ingredients. The dry ingredients comprise: (i) a protein component that comprises a plant-derived protein material, wherein the protein component is at an amount that is no more than about 90% by weight of the dry ingredients; (ii) a carbohydrate component at an amount that is in the range of about 2 to about 50% by weight of the dry ingredients; and (iii) a lipid component at an amount that is in the range of about 0.1 to about 5% by weight of the dry ingredients. The wet ingredients comprise water.

Still further, the present invention is directed to a meat analog composition comprising a structured plant protein product, wherein the structured plant protein product has a moisture content that is at least about 50% by weight of the structured plant protein product, and wherein the structured plant protein product comprises protein fibers that are substantially aligned. The protein fibers comprise (a) dry ingredients and (b) wet ingredients. The dry ingredients comprise: (i) a protein component that comprises a plant-derived protein material, wherein the protein component is at an amount that is no more than about 90% by weight of the dry ingredients; (ii) a carbohydrate component at an amount that is in the range of about 2 to about 50% by weight of the dry ingredients; and (iii) a lipid component at an amount that is in the range of about 0.1 to about 5% by weight of the dry ingredients. The wet ingredients comprise water.

Also, the present invention is directed to a food application comprising above-described meat analog composition.

### BRIEF DESCRIPTION OF THE DRAWINGS

FIGS. 1(a) and 1(b) are photographic images of a micrograph showing a meat analog composition not produced by the process as described herein having protein fibers that are not substantially aligned.

FIGS. 2(a) and 2(b) are photographic images of a micrograph showing a meat analog composition produced by the process as described herein having protein fibers that are substantially aligned and has an acceptable meat-like moisture, texture, mouthfeel, flavor and color.

FIGS. 3(a) and 3(b) are photographic images of a micrograph showing a meat analog composition produced by the process as described herein having protein fibers that are substantially aligned and has an acceptable meat-like moisture, texture, mouthfeel, flavor and color.

FIGS. 4(a) and 4(b) are photographic images of a micrograph showing a meat analog composition produced by the process as described herein having protein fibers that are substantially aligned and has an acceptable meat-like moisture, texture, mouthfeel, flavor and color.

FIGS. 5(a) and 5(b) are photographic images of a micrograph showing a meat analog composition produced by the process as described herein having protein fibers that are substantially aligned and has an acceptable meat-like moisture, texture, mouthfeel, flavor and color.

FIGS. 6(a) and 6(b) are photographic images of a micrograph showing a meat analog composition produced by the process as described herein having protein fibers that are substantially aligned and has an acceptable meat-like moisture, texture, mouthfeel, flavor and color.

FIGS. 7(a) and 7(b) are photographic images of a micrograph showing a meat analog composition produced by the process as described herein having protein fibers that are substantially aligned and has an acceptable meat-like moisture, texture, mouthfeel, flavor and color.

FIGS. 8(a) and 8(b) are photographic images of a micrograph showing a meat analog composition produced by the process as described herein having protein fibers that are substantially aligned and has an acceptable meat-like moisture, texture, mouthfeel, flavor and color.

FIGS. 9(a) and 9(b) are photographic images of a micrograph showing a meat analog composition produced by the process as described herein having protein fibers that are substantially aligned and has an acceptable meat-like moisture, texture, mouthfeel, flavor and color.

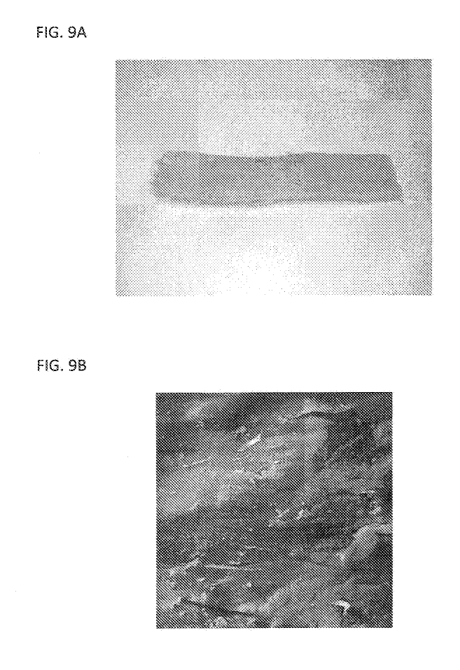

### DETAILED DESCRIPTION OF THE INVENTION

### I. DEFINITIONS

The term “animal meat” as used herein refers to the flesh, whole meat muscle, or parts thereof derived from an animal.

The term “gluten” as used herein refers to a protein fraction in cereal grain flour, such as wheat, that possesses a high content of protein as well as unique structural and adhesive properties.

The term “soy cotyledon fiber” as used herein refers to the polysaccharide portion of soy cotyledons containing at least about 70% dietary fiber. Soy cotyledon fiber typically contains some minor amounts of soy protein, but may also be 100% fiber. Soy cotyledon fiber, as used herein, does not refer to, or include, soy hull fiber. Generally, soy cotyledon fiber is formed from soybeans by removing the hull and germ of the soybean, flaking or grinding the cotyledon, removing oil from the flaked or ground cotyledon, and separating the soy cotyledon fiber from the soy material and carbohydrates of the cotyledon.

The term “soy flour” as used herein, refers to a comminuted form of defatted soybean material, containing less than about 1% oil, formed of particles having a size such that the particles can pass through a No. 100 mesh (U.S. Standard) screen. The soy cake, chips, flakes, meal, or mixture of the materials are comminuted into soy flour using conventional soy grinding processes. Soy flour has a soy protein content of about 49% to about 65% on a moisture free basis.

The term “soy protein concentrate” as used herein is a soy material having a protein content of about 65% to less than about 90% soy protein on a moisture-free basis. Soy protein concentrate also contains soy cotyledon fiber, typically about 3.5% up to about 20% soy cotyledon fiber by weight on a moisture-free basis. A soy protein concentrate is formed from soybeans by removing the hull and germ of the soybean, flaking or grinding the cotyledon, removing oil from the flaked or ground cotyledon, and separating the soy protein and soy cotyledon fiber from the soluble carbohydrates of the cotyledon.

The term “soy protein isolate” as used herein is a soy material having a protein content of at least about 90% soy protein on a moisture free basis. A soy protein isolate is formed from soybeans by removing the hull and germ of the soybean from the cotyledon, flaking or grinding the cotyledon, removing oil from the flaked or ground cotyledon, separating the soy protein and carbohydrates of the cotyledon from the cotyledon fiber, and subsequently separating the soy protein from the carbohydrates.

The term “starch” as used herein refers to starches derived from any native source. Typically, sources for starch are cereals, tubers, roots, legumes, and fruits.

The term “wheat flour” as used herein refers to flour obtained from the milling of wheat.

### II. MEAT ANALOG COMPOSITIONS

The present disclosure describes meat analog compositions that comprise structured plant protein products comprising protein fibers that are substantially aligned. In addition to structured plant protein products, the meat analog compositions may optionally include other constituents such as animal meat, emulsifiers, cereal components and starch, edulcorants, sweeteners, polyalcohols, salts, colorings, fiber, flavorings, spices, antioxidants, nutritional enhancements, etc. The present disclosure also describes a process for producing the meat analog compositions.

More specifically, it has been discovered that meat analog compositions having qualities (e.g., texture, moisture, mouthfeel, flavor, and color) similar to that of whole muscle animal meat may be produced using structured plant protein products formed using extrusion under conditions of relatively high moisture and, optionally, under relatively low pH conditions from a composition comprising relatively low protein content, one or more of flour, starch, and edible fiber, and optionally an edible lipid material. As a result, such meat analog compositions may be used in a variety of food applications thereby allowing the content of meat therein to be reduced or even eliminated.

### A. Structured Plant Protein Products

The meat analog compositions comprise structured plant protein products comprising protein fibers that are substantially aligned and it is this alignment of protein fibers that are believed to substantially contribute to the structured plant protein products having a texture similar to that of whole meat muscle to the plant protein products. As such, it tends to be desirable for the structured plant protein products to consist essentially of or even consist of such protein fibers. To be clear, as used herein, the terms “protein fiber” or “protein fibers” means individual continuous filament(s) or fiber(s) of varying lengths comprising plant-derived protein and one or more of flour, starch, and edible fiber that are formed by a wet extrusion process. The protein fibers may also comprise optional ingredients such as an edible lipid material, animal meat, emulsifiers, pH-lowering agents, etc.

1. Protein Component

The aforementioned protein in said protein fibers are from a protein component that is included in the mixture to be extruded. The protein component comprises one or more sources of protein, including plant-derived proteins and, optionally, animal meat proteins (which are described in detail below). A variety of ingredients that contain protein may be utilized in an extrusion process to produce structured plant protein products suitable for use in meat analog compositions. While ingredients comprising proteins derived from plants are typically used, it is also envisioned that proteins derived from other sources, such as animal sources, may be utilized without departing from the scope of the disclosure. Irrespective of source or ingredient classification, the ingredients utilized in the extrusion process are typically capable of forming structured plant protein-containing products having protein fibers that are substantially aligned. Suitable examples of such ingredients are detailed more fully below.

In an exemplary embodiment, at least one ingredient is a plant derived protein-containing material. The amount of protein present in the ingredient(s) utilized to make structured plant protein products may be varied depending upon the application. Without being held to a particular theory, it is believed that reducing the amount of protein present in the ingredients utilized to make structured plant protein products in conjunction with relatively high moisture extrusion and one or more of flour, starch, and edible fiber results in an extrudate with protein fibers that may be used to make meat analog compositions that more closely simulate animal muscle meat. In one embodiment, the amount of protein included in the mixture to be extruded comprises no more than about 90% by weight of the dry ingredients. For example, the amount of protein present in the ingredients utilized to make structured plant protein products may range from about 40% to about 90% by weight of the dry ingredients. In certain embodiments the amount of protein present in the ingredients utilized to make structured plant protein products may range from about 50% to about 90% by weight of the dry ingredients. In a further embodiment, the amount of protein present in the dry ingredients utilized to make structured plant protein products may range from about 60% to about 90% by weight. In another further embodiment, the amount of protein present in the dry ingredients utilized to make structured plant protein products is about 80%.

The term “dry ingredients” includes all the ingredients in the mixture to be extruded except for added water and ingredients added with the added water (i.e., the “wet ingredients”) such as the pH-lowering agent as described below. Thus, the dry ingredients include the protein component, the carbohydrate component, and the edible lipid component (despite the fact that the edible lipid component may be a liquid oil).

Additionally, it is to be noted that when ranges are set forth herein for any particular component, constituent, ingredient, etc. it is contemplated that in addition to any such expressly disclosed ranges all other possible range permutations involving any particular lower range threshold and any particular upper range threshold are impliedly disclosed.

a. Soy Protein Materials

In one embodiment, the plant protein ingredients are isolated from soybeans. Suitable soybean derived protein-containing ingredients (“soy protein material”) include soy protein isolate, soy protein concentrate, soy flour, and mixtures thereof. The soy protein materials may be derived from whole soybeans in accordance with methods generally known in the art. The whole soybean may be non-genetically modified soybeans, commoditized soybeans, hybridized soybeans, genetically-modified soybeans, preserved soybeans, and combinations thereof.

Generally speaking, when soy protein isolate is used, an isolate may be selected that is not a highly hydrolyzed soy protein isolate. There are several reasons as to why someone would seek to avoid or minimize the amount of highly hydrolyzed soy protein isolate. For example, highly hydrolyzed soy protein isolate tends to be relatively costly. Also, without being bound to a particular theory, it is believed extruded fibers formed therefrom are of lesser quality because the hydrolyzed soy protein isolated tends to have relatively short protein chains (relatively low molecular weight). Additionally, it has been found that including highly hydrolyzed soy protein isolate can impart bitterness. Nevertheless, in certain embodiments highly hydrolyzed soy protein isolates may be used in combination with other soy protein isolates. Alternatively, soy protein concentrate or soy flour may be blended with the soy protein isolate to substitute for a portion of the soy protein isolate as a source of soy protein material.

b. Other Plant Proteins

In another exemplary embodiment, the plant protein ingredients are isolated from algae, cottonseed, oats, wheat, peas, soybeans, or combinations thereof. Suitable wheat derived protein-containing ingredients include wheat gluten, wheat flour, and mixtures thereof.

2. Carbohydrate Component

In addition to a protein component, the structured plant protein products described herein comprise a carbohydrate component. A variety of ingredients may be used as all or part of the carbohydrate component. That said, such ingredients are typically classified as a starch, a flour, or an edible fiber and the carbohydrate component may comprise one or more types of starch, flour, edible fiber, and combinations thereof. Examples of starch include wheat starch, corn starch, rice starch, oat starch, potato starch, and combinations thereof. Examples of flour include wheat flour, rice flour, white corn flour, oat flour, sorghum flour, rye flour, amaranth flour, quinoa flour, and combinations thereof.

Edible fiber is a particularly advantageous carbohydrate to include in the extrusion mixture because fiber tends to bind water when the mixture is extruded. Any appropriate type of edible fiber may be used in the present invention in appropriate amounts. Exemplary sources of edible fiber include soluble and insoluble dietary fiber, wood pulp cellulose, modified cellulose, seed husks, oat hulls, citrus fiber, carrot fiber, pea fiber, corn bran, soy polysaccharide, oat bran, wheat bran, barley bran, and rice bran. The fiber may be present in the dry pre-mix from about 0.1% to about 10% by weight. In one embodiment, the fiber is about 2% to about 8% by weight of the dry ingredients. In another embodiment the fiber is about 5% by weight of the dry ingredients. Particularly desirable types of fiber are those that effectively bind water when the mixture of plant protein and fiber is extruded. In this context, “effectively bind water” generally means that the fiber has a water holding capacity of at least 5.0 to about 8.0 grams of water per gram of fiber. Particularly desirable types of fiber include soy cotyledon fiber, carrot fiber, pea fiber, oat bran, and combinations thereof.

In one embodiment, the protein-containing material comprises protein, starch, gluten, and edible fiber (e.g., carrot fiber). In another embodiment the protein-containing material comprises protein derived from soybeans and one or more ingredients selected from the group consisting of a starch, flour, gluten, an edible fiber, and mixtures thereof. In another embodiment the protein-containing material comprises protein derived from peas and one or more ingredients selected from the group consisting of a starch, flour, gluten, an edible fiber, and mixtures thereof.

3. Edible Lipid Component

In addition to the foregoing, the ingredients utilized to make the structured plant protein product may comprise an edible lipid component that comprises one or more edible lipids. One of the benefits provided by edible lipids is that their inclusion tends to improve the tenderness of the protein fibers. In particular, it has been found that including relatively small amounts of edible lipids (e.g., as little as about 0.1% by weight of the dry ingredients) may have a beneficial effect on the texture and tenderness of the formed protein fibers. It has also been discovered that in general increasing the total edible lipid content tends to increase tenderness but the but the total edible lipid content is preferably not so high as to compromise the desired properties of the protein fibers because there is not enough friction in the cooling die. Results to date indicate that the total edible lipid content is preferably no more than about 5% of the weight of the dry ingredients utilized the make the structured plant protein product. As such, in one embodiment, the total edible lipid content is an amount of about 0.1% to about 5% by weight of the dry ingredients. In another embodiment, the total edible lipid content is an amount of about 1% to about 3% by weight of the dry ingredients. In yet another embodiment, the total amount of edible lipids is about 3% by weight of the dry ingredients.

Practically any edible lipid material may be employed, including natural and synthetic oils, for example, rapeseed, canola, soybean, cottonseed, peanut, palm and corn oils and in either non-hydrogenated or partially hydrogenated form. In one embodiment, the edible lipid material is an edible vegetable oil, such as canola oil, cottonseed oil, peanut oil, and olive oil.

In one embodiment, the edible lipid material is canola oil in the amount of about 1% to about 5%, and more specifically about 3% based on the weight of the dry product.

4. Moisture Content

In addition to the foregoing, the structured plant protein product comprises water at a relatively high amount. In particular, the total moisture level of the mixture extruded to make the structured plant protein product is controlled such that the structured plant protein product has a moisture content that is at least about 50% by weight. To achieve such a high moisture content, water is typically added to the ingredients. Although, a relatively high moisture content is desirable, results to date indicate that it is not desirable for the structured plant protein product to have a moisture content much greater than about 75%. As such, in one embodiment the amount of water added to the ingredients and the extrusion process parameters are controlled such that the structured plant protein product (following extrusion) has a moisture content that is from about 50% to about 75% by weight. In another embodiment, the moisture is about 55% to about 70% by weight. In still another embodiment, the moisture is about 60% to about 65% by weight. In yet another embodiment, the moisture content is about 65% by weight.

5. pH-lowering Agent

The meat analog compositions may be produced under conditions of reduced pH because doing so tends to enhance tenderness. In general, reducing the pH is achieved by mixing a pH-lowering agent with the water to be injected into the extruder. Alternatively, the pH-lowering agent may be contacted with the structured plant protein product after it has been extruded. Irrespective of the stage of manufacture at which the pH-lowering agent is introduced, suitable agents include those that will lower the pH of the composition. The pH of the pH-lowering agent will generally be acidic (i.e., below approximately 7.0). In one embodiment, the pH is below approximately 7.0. In another embodiment, the pH is between about 6.0 to about 7.0. In still another embodiment, the pH is below approximately 6.0. In another embodiment, the pH is between about 5.0 and about 6.0. In one alternative of this embodiment, the pH is between about 5.2 to about 5.9. In still another alternative of this embodiment, the pH is between about 5.4 to about 5.8. In an additional alternative of this embodiment, the pH is about 5.6. In another embodiment, the pH is below approximately 5.0. In a further embodiment, the pH is between about 4.0 to about 5.0. In still another embodiment, the pH is below approximately 4.0.

The pH-lowering agent may be organic or inorganic. In exemplary embodiments, the pH-lowering agent is a food grade edible acid. Non-limiting examples of acids suitable for use include acetic, lactic, hydrochloric, phosphoric, citric, tartaric, malic, and combinations thereof. As will be appreciated by a skilled artisan, the amount of pH lowering agent utilized in the process can and will vary depending upon several parameters, including, the agent selected, the desired pH, and the stage of manufacture at which the agent is added. By way of non-limiting example, the amount of pH-lowering agent included in the water used to make the structured plant protein product (for applications in which the pH-lowering agent is added before extrusion of the mixture) or the meat analog composition (for applications where the agent is added after extrusion) may range from about 0.1% to about 5% by volume of water added. In another embodiment, the amount of pH-lowering agent may range from about 0.2% to about 4% by volume of water added. In an additional embodiment, the amount of pH lowering agent may range from about 0.3% to about 3% by volume of water added. In other embodiments, the amount of pH-lowering agent may range from about 0.4% to about 2% by volume of water added. In another embodiment, the amount of pH-lowering agent is about 0.5% to about 1% by volume of water added.

6. Additional Ingredients

Additives like emulsifiers, edulcorants such as corn sweeteners, sugars and artificial sweeteners, sorbitol, polyalcohols such as glycerine, alkylene glycols, salts, colorings, and other ingredients may be added to the extent that they do not interfere with the production of the meat analog that simulates the fibrous structure of animal meat and has an acceptable meat-like moisture, texture, mouthfeel, flavor, and color. Examples of emulsifiers are lecithins and derivatives thereof, among others. Examples of polyalcohols are glycerol, propylene glycol, butanediols, mannitol, sorbitol, and xylitol.

Salt, sugars, acids, spices, smoke and fruit-like flavors, antioxidants to protect the fat against oxidation, and plasticizing materials such as sugar, corn syrups, glycerol, sorbitol, and antimicrobial preservatives like potassium sorbate and propylene glycol that are volatile heat labile are preferably added after extrusion.

Additionally, antioxidants, antimicrobial agents, and combinations thereof may be included. Antioxidant additives include BHA, BHT, TBHQ, vitamins A, C and E and derivatives, and various plant extracts such as those containing carotenoids, tocopherols or flavonoids having antioxidant properties, may be included to increase the shelf-life or nutritionally enhance the meat analog compositions. The antioxidants and the antimicrobial agents may have a combined presence at levels of from about 0.01% to about 10%, or more specifically, from about 0.05% to about 5%, and even more specifically from about 0.1% to about 2%, by weight on a dry matter basis.

### B. Extrusion Process

A suitable extrusion process for the preparation of the structure plant protein product comprises introducing protein component, the carbohydrate component, and other ingredients such as an edible lipid into a mixing tank (i.e., an ingredient blender such as a Hobart Mixer (Hobart Corp., Troy, Ohio)) to combine the ingredients and form a dry blended pre-mix. As detailed above, in certain embodiments the pH-lowering agent may be mixed with water to be injected into the extruder. The dry blended pre-mix is then transferred to a hopper from which the dry blended ingredients are fed to an extruder in which the dry ingredients and injected water are mixed and heated under mechanical pressure generated by the screws of the extruder to form a molten extrusion mass. The molten extrusion mass exits the extruder through an extrusion die.

1. Extrusion Equipment and Process Conditions

Among the suitable extrusion apparatuses useful in the practice of the described process is a double barrel, twin-screw extruder as described, for example, in U.S. Pat. No. 4,600,311. Further examples of suitable commercially available extrusion apparatuses include a MPF 50/25 model manufactured by APV Baker Inc. (Grand Rapids, Mich.); CLEXTRAL Model BC-72 extruder manufactured by Clextral, Inc. (Tampa, Fla.); a WENGER Model TX-57 extruder, a WENGER Model TX-168 extruder, and a WENGER Model TX-52 extruder all manufactured by Wenger Manufacturing, Inc. (Sabetha, Kans.). Other suitable conventional extruders are described, for example, in U.S. Pat. Nos. 4,763,569, 4,118,164, and 3,117,006, which are hereby incorporated by reference in their entirety.

The screws of a twin-screw extruder can rotate within the barrel in the same or opposite directions. Rotation of the screws in the same direction is referred to as single flow or co-rotating whereas rotation of the screws in opposite directions is referred to as double flow or counter-rotating. The speed of the screw or screws of the extruder may vary depending on the particular apparatus; however, it is typically from about 100 to about 450 revolutions per minute (rpm) and results to date indicate that a screw speed of about 120 to about 250 rpm may be preferable. Generally, as the screw speed increases, the density of the extrudate will decrease. The extrusion apparatus contains screws assembled from shafts and worm segments, as well as mixing lobe and ring-type shearing elements as recommended by the extrusion apparatus manufacturer for extruding plant protein material.

The extrusion apparatus generally comprises a plurality of heating zones through which the protein mixture is conveyed under mechanical pressure prior to exiting the extrusion apparatus through an extrusion die. The temperature in each successive heating zone generally exceeds the temperature of the previous heating zone by between about 10° C. to about 70° C. In one embodiment, the dry premix is transferred through five heating zones within the extrusion apparatus, with the protein mixture heated to a temperature of from about 25° C. to about 170° C. such that the molten extrusion mass enters the extrusion die at a temperature of from about 170° C. In one embodiment, the protein mixture is heated in the respective heating zones to temperatures of about 25° C., about 40° C., about 95° C., about 150° C. and about 170° C. One skilled in the art may adjust the temperatures in one or more zones to achieve the desired properties.

The pressure within the extruder barrel is typically between about 30 psig and about 500 psig, or more specifically between about 50 psig and about 300 psig. Generally, the pressure within the last two heating zones is between about 50 psig and about 500 psig, even more specifically between about 50 psig to about 300 psig. The barrel pressure is dependent on numerous factors including, for example, the extruder screw speed, feed rate of the mixture to the barrel, feed rate of water to the barrel, and the viscosity of the molten mass within the barrel.

Water is injected into the extruder barrel to hydrate the plant protein material mixture and promote texturization of the proteins. As an aid in forming the molten extrusion mass, the water may act as a plasticizing agent. Water may be introduced to the extruder barrel via one or more injection jets. The rate of introduction of water to the barrel is generally controlled to promote production of an extrudate having the aforementioned desired characteristics, such as an extrudate with a moisture content as described above (e.g., in one embodiment, about 65% moisture).

2. Detailed Process Description

The pre-mixer contains one or more paddles to promote uniform mixing of the protein, edible lipid material and other ingredients. The configuration and rotational speed of the paddles vary widely, depending on the capacity of the pre-mixer. The pre-mix is fed into an extruder to heat, shear, and ultimately plasticize the mixture. The extruder may be selected from any commercially available extruder that mechanically shears the mixture with the screw elements.

The pre-mix is subjected to shear and pressure by the extruder to plasticize the mixture. The screw elements of the extruder shear the mixture as well as create pressure in the extruder by forcing the mixture forwards through the extruder and through the die. The screw motor speed is typically set to a speed of about 100 rpm to about 500 rpm. In one embodiment, the screw motor speed is about 100 rpm to about 200 rpm. In another embodiment, the screw motor speed is set at about 140 rpm.

The extruder controls the temperature of the mixture as it passes through the extruder denaturing the protein in the mixture. The extruder includes a means for controlling the temperature of the mixture such as extruder barrel jackets into which heating or cooling media such as steam or chilled water may be introduced to control the temperature of the mixture passing through the extruder. The extruder may also include steam injection ports for directly injecting steam into the mixture within the extruder. In one embodiment, the extruder includes multiple heating zones that can be controlled to independent temperatures, where the temperatures of the heating zones are set to control the temperature of the mixture as it proceeds through the extruder. For example, the extruder may be set in a five temperature zone arrangement, where the first zone (adjacent the extruder inlet port) is set to a temperature of about 20° C. to about 30° C., the second zone is set to a temperature of about 30° C. to about 50° C., the third zone is set to a temperature of 85° C. to about 105° C., the fourth zone is set to a temperature of about 130° C. to about 160° C., and the fifth zone (adjacent the extruder exit port) is set to a temperature of about 140° C. to about 180° C. The extruder may be set in other temperature zone arrangements, as desired.

The mixture forms a melted plasticized mass in the extruder. A die assembly is attached to the extruder in an arrangement that permits the plasticized mixture to flow from the extruder exit port into a long cooling die. Additionally, the cooling die produces substantial alignment of the protein fibers within the plasticized mixture as it flows through the die. The width and height dimensions of the cooling die are selected and set prior to extrusion of the mixture to provide the fibrous material extrudate with the desired dimensions. The width of the die aperture(s) may be set so that the extrudate resembles from a cubic chunk of meat to a steak filet, where widening the width of the die aperture(s) decreases the cubic chunk-like nature of the extrudate and increases the filet-like nature of the extrudate. In one embodiment, the width of the die aperture(s) is/are set to a width of from about 20 millimeters to about 120 millimeters, or more specifically about 60-80 millimeters. The height dimension of the die aperture(s) may be set to provide the desired thickness of the extrudate. The height of the aperture(s) may be set to provide a very thin extrudate or a thick extrudate. The height of the die aperture(s) may be set to from about 1 millimeter to about 25 millimeters, and more specifically from about 5 millimeters to about 15 millimeters. It is also contemplated that the die aperture(s) may be round. The diameter of the die aperture(s) may be set to provide the desired thickness of the extrudate. The diameter of the aperture(s) may be set to provide a very thin extrudate or a thick extrudate. The diameter of the die aperture(s) may be set to from about 1 millimeter to about 30 millimeters, and more specifically from about 8 millimeters to about 16 millimeters. The length of the die may be from about 200 to about 500 millimeters, even more specifically from about 300 to about 400 millimeters. Chilled water (e.g., from about 2 to about 8° C.) is often used as the cooling medium and circulated through the cooling die.

The extrudate may be cut after exiting the cooling die. Suitable apparatuses for cutting the extrudate after it exits the die assembly include flexible knives manufactured by Wenger Manufacturing, Inc. (Sabetha, Kans.) and Clextral, Inc. (Tampa, Fla.). A delayed cut can also be done to the extrudate. One such example of a delayed cut device is a guillotine device.

A dryer may optionally be used to dry the extrudate. The dryer, if one is used, generally comprises one or more drying zones. The extrudate will be present in the dryer for a time sufficient to produce an extrudate having the desired moisture content. Thus, the temperature of the air is not important, if a lower temperature is used longer drying times will be required than if a higher temperature is used. Generally, the temperature and duration of the drying step are well known to those skilled in the art.

### C. Characterization of the Structured Plant Protein Products

As mentioned above, the extrudates (or structured plant protein products) produced in accordance with the process described herein comprise protein fibers that are substantially aligned. As used herein, “substantially aligned” generally refers to the arrangement of protein fibers such that a significantly high percentage of the protein fibers of the structured plant protein product are contiguous to each other at less than approximately a 45° angle when viewed in a horizontal plane. Typically, an average of at least about 55% of the protein fibers comprising the structured plant protein product are substantially aligned. In another embodiment, an average of at least about 60% of the protein fibers are substantially aligned. In a further embodiment, an average of at least about 70% of the protein fibers are substantially aligned. In an additional embodiment, an average of at least about 80% of the protein fibers are substantially aligned. In yet another embodiment, an average of at least 90% of the protein fibers are substantially aligned. Methods for determining the degree of protein fiber alignment are known in the art and include visual determinations based upon photographs and micrographic images.

In addition to having protein fibers that are substantially aligned, the structured plant protein products preferably have an average Warner-Bratzler shear force that is substantially similar to that of whole meat muscle. Generally speaking, the structured plant protein products have an average Warner-Bratzler shear force of less than 60 g/mm². Preferably, the structure plant protein products have an average Warner-Bratzler shear force of less than 50 g/mm². In one additional embodiment, the structured plant protein products have an average Warner-Bratzler shear force of about 25 to about 50 g/mm². In yet another embodiment, the structured plant protein products have an average Warner-Bratzler shear strength of about 30 to about 40 g/mm². In general, as Warner-Bratzler shear force numbers decreases the extrudate is more tender. It is also to be noted that the tongue of the extrusion device and the die pressure are also indicative of the tenderness of the extruded plant protein product.

### III. ANIMAL MEAT

The meat analog compositions may optionally comprise animal meat, which may be included in the protein components used in the formation of the structure protein product and/or as a constituent of the meat analog compositions in addition to the structure protein product.

### A. Types of Animal Meats

By way of example, meat and meat ingredients may include intact or ground beef, pork, lamb, mutton, horsemeat, goat meat, meat, fat and skin of poultry (domestic fowl such as chicken, duck, goose or turkey) and more specifically flesh tissues from any fowl (any bird species), fish flesh derived from both fresh and salt water fish such as catfish, tuna, sturgeon, salmon, bass, muskie, pike, bowfin, gar, paddlefish, bream, carp, trout, walleye, snakehead and crappie, animal flesh of shellfish and crustacean origin, animal flesh trim and animal tissues derived from processing such as frozen residue from sawing frozen fish, chicken, beef, pork etc., chicken skin, pork skin, fish skin, animal fats such as beef fat, pork fat, Iamb fat, chicken fat, turkey fat, rendered animal fat such as lard and tallow, flavor enhanced animal fats, fractionated or further processed animal fat tissue, finely textured beef, finely textured pork, finely textured lamb, finely textured chicken, low temperature rendered animal tissues such as low temperature rendered beef and low temperature rendered pork, mechanically separated meat or mechanically deboned meat (MDM) (meat flesh removed from bone by various mechanical means) such as mechanically separated beef, mechanically pork, mechanically separated fish, mechanically separated chicken, mechanically separated turkey, any cooked animal flesh and organ meats derived from any animal species. Meat flesh should be extended to include muscle protein fractions derived from salt fractionation of the animal tissues, protein ingredients derived from isoelectric fractionation and precipitation of animal muscle or meat and hot boned meat as well as mechanically prepared collagen tissues and gelatin. Additionally, meat, fat, connective tissue and organ meats of game animals such as buffalo, deer, elk, moose, reindeer, caribou, antelope, rabbit, bear, squirrel, beaver, muskrat, opossum, raccoon, armadillo and porcupine as well as well as reptilian creatures such as snakes, turtles and lizards should be considered meat.

It is also envisioned that a variety of meat qualities may be utilized depending upon the product's intended use. For example, whole meat muscle that is either ground or in chunk or steak form may be utilized. In an additional embodiment, mechanically deboned meat (MDM) may be utilized. As used herein, “MDM” is a meat paste that is recovered from a variety of animal bones, such as, beef, pork and chicken bones, using commercially available equipment. MDM is generally a comminuted product that is devoid of the natural fibrous texture found in intact muscles. In other embodiments, a combination of MDM and whole meat muscle may be utilized.

### B. Process for Producing Food Applications Comprising Animal Meat

Another aspect of this disclosure provides a process for producing meat analog compositions that comprise animal meat. A meat analog composition may be produced, for example, using process that comprises adding the animal meat to extrusion mixture. Animal meat may also be added to the structured plant protein product by hydrating the, reducing the size of the structured plant protein product, if necessary, optionally flavoring and coloring the structured plant protein product, and mixing it with animal meat. Further, if desired, other constituents (e.g., dietary fiber) may also be added to the mixture of animal meat and structure plant protein product. The meat analog composition may be further processed into a food application.

In addition to animal meat, other animal-derived protein materials include, for example, casein, caseinates, whey protein, milk protein concentrate, milk protein isolate, ovalbumin, ovoglobulin, ovomucin, ovomucoid, ovotransferrin, ovovitella, ovovitellin, albumin globulin, vitellin, and combinations thereof

### C. Blending Structured Plant Protein Products with Animal Meat

As noted above, the hydrated structured plant protein product may be blended with animal meat to produce animal meat compositions. Any of the animal meats detailed above or otherwise known in the art may be utilized. In general, the structured plant protein product will be blended with animal meat that has a similar particle size. Typically, the amount of structured plant protein product in relation to the amount of animal meat in the animal meat compositions can and will vary depending upon the composition's intended use. By way of example, when a significantly vegetarian composition that has a relatively small degree of animal flavor is desired, the concentration of animal meat in a meat analog composition may be about 45%, about 40%, about 35%, about 30%, about 25%, about 20%, about 15%, about 10%, about 5%, about 2%, or 0% by weight. Alternatively, when a meat analog composition having a relatively high degree of animal meat flavor is desired, the concentration of animal meat may be about 50%, about 55%, about 60%, about 65%, about 70%, or about 75% by weight. Consequently, the concentration of the hydrated structured plant protein product in the analog meat composition may be about 25%, about 30%, about 35%, about 40%, about 45%, about 50%, about 55%, about 60%, about 65%, about 70%, about 75%, about 80%, about 85%, about 90%, about 95%, or about 99% by weight. In alternative embodiments, any desirable concentration of animal meat may be used.

Depending upon the food application, the animal meat is typically precooked to partially dehydrate the flesh and prevent the release of those fluids during further processing applications (e.g., such as retort cooking), to remove natural liquids or oils that may have strong flavors, to coagulate the animal protein and loosen the meat from the skeleton, or to develop desirable and textural flavor properties. The precooking process may be carried out in steam, water, oil, hot air, smoke, or a combination thereof. The animal meat is generally heated until the internal temperature is between about 60° C. and about 85° C. In one embodiment, the animal meat composition is mixed with the hydrated structured plant protein at an elevated temperature corresponding to the temperature of the meat product.

### IV. COLORING AGENTS

It is also envisioned that the meat analog composition may also comprise a suitable coloring agent such that the color of the composition resembles the color of animal meat it is to simulate. In one embodiment, coloring agents are added to the mixture that is to be extruded. The compositions may be colored to resemble dark animal meat or light animal meat. By way of example, the composition may be colored with a natural colorant, a combination of natural colorants, an artificial colorant, a combination of artificial colorants, or a combination of natural and artificial colorants. Suitable examples of natural colorants approved for use in food include annatto (reddish-orange), anthocyanins (red to blue, depends upon pH), beet juice, beta-carotene (orange), beta-APO 8 carotenal (orange), black currant, burnt sugar; canthaxanthin (pink-red), caramel, carmine/carminic acid (bright red), cochineal extract (red), curcumin (yellow-orange); lutein (red-orange); mixed carotenoids (orange), monascus (red-purple, from fermented red rice), paprika, red cabbage juice, riboflavin (yellow), saffron, titanium dioxide (white), and turmeric (yellow-orange). Suitable examples of artificial colorants approved for use in food include FD&C (Food Drug & cosmetics) Red Nos. 3 (carmosine), 4 (fast red E), 7 (ponceau 4R), 9 (amaranth), 14 (erythrosine), 17 (allura red), 40 (allura red AC) and FD&C Yellow Nos. 5 (tartrazine), 6 (sunset yellow) and 13 (quinoline yellow). Food colorants may be dyes, which are powders, granules, or liquids that are soluble in water. Alternatively, natural and artificial food colorants may be lake colors, which are combinations of dyes and insoluble materials. Lake colors are not oil soluble, but are oil dispersible; they tint by dispersion.

The type of colorant or colorants and the concentration of the colorant or colorants may be adjusted to match the color of the animal meat to be simulated. Typically, the concentration of a natural food colorant may range from about 0.01% percent to about 4% by weight of the meat analog composition. The color system may further comprise an acidity regulator to maintain the pH in the optimal range for the colorant.

### V. OTHER OPTIONAL INGREDIENTS

The meat analog compositions may optionally include a variety of flavorings, spices, antioxidants, fibers, or other ingredients to nutritionally enhance the final food application. As will be appreciated by one skilled in the art, the selection of ingredients added to the meat analog composition can and will depend upon the food application to be manufactured.

### A. Antioxidants

The meat analog compositions may further comprise an antioxidant. The antioxidant may prevent the oxidation of the polyunsaturated fatty acids (e.g., omega-3 fatty acids) in the animal meat, and the antioxidant may also prevent oxidative color changes in the colored structured plant protein product and the animal meat. The antioxidant may be natural or synthetic. Suitable antioxidants include, but are not limited to, ascorbic acid and its salts, ascorbyl palmitate, ascorbyl stearate, anoxomer, N-acetylcysteine, benzyl isothiocyanate, butylated hydroxyanisole (BHA), butylated hydroxytoluene (BHT), caffeic acid, canthaxantin, alpha-carotene, beta-carotene, beta-carotene, beta-apo-carotenoic acid, carnosol, carvacrol, catechins, acetyl gallate, chlorogenic acid, citric acid and its salts, clove extract, coffee bean extract, p-coumaric acid, 3,4-dihydroxybenzoic acid, N,N′diphenyl-p phenylenediamine (DPPD), dilauryl thiodipropionate, di-stearyl thiodipropionate, 2,6-di-tert-butyiphenol, dodecyl gallate, edetic acid, ellagic acid, erythorbic acid, sodium erythorbate, esculetin, esculin, 6-ethoxy 1,2-dihydro-2,2,4-trimethylquinoline, ethyl gallate, ethyl maltol, ethylenediaminetetraacetic acid (EDTA), eucalyptus extract, eugenol, ferulic acid, flavonoids, flavones (e.g., apigenin, chrysin, luteolin), flavonols (e.g., datiscetin, myricetin, daemfero), flavanones, fraxetin, fumaric acid, gallic acid, gentian extract, gluconic acid, glycine, gum guaiacum, hesperetin, alpha-hydroxybenzyl phosphinic acid, hydroxycinammic acid, hydroxyglutaric acid, hydroquinone, N-hydroxysuccinic acid, hydroxytryrosol, hydroxyurea, rice bran extract, lactic acid and its salts, lecithin, lecithin citrate; R-alpha-lipoic acid, lutein, lycopene, malic acid, maltol, 5-methoxy tryptamine, methyl gallate, monoglyceride citrate; mono isopropyl citrate; morin, Beta naphthoflavone, nordihydroguaiaretic acid (NDGA), octyl gallate, oxalic acid, palmityl citrate, phenothiazine, phosphatidylcholine, phosphoric acid, phosphates, phytic acid, phytylubichromel, pimento extract, propyl gallate, polyphosphates, quercetin, trans resveratrol, rosemary extract, rosmarinic acid, sage extract, sesamol, silymarin, sinapic acid, succinic acid, stearyl citrate, syringic acid, tartaric acid, thymol, tocopherols (i.e., alpha-, beta-, gamma- and delta-tocopherol), tocotrienols (i.e., alpha-, beta-, gamma- and delta-tocotrienols), tyrosol, vanillic acid, 2,6-di-tert-butyl-4-hydroxymethylphenol (i.e., Ionox 100), 2,4-(tris-3′,5′-bitert-butyl-4′-hydroxybenzyl)-mesitylene (i.e., Ionox 330), 2,4,5-trihydroxybutyrophenone, ubiquinone, tertiary butyl hydroquinone (TBHO), thiodipropionic acid, trihydroxy butyrophenone, tryptamine, tyramine, uric acid, vitamin K and derivates, wheat germ oil, zeaxanthin, or combinations thereof. The concentration of an antioxidant in a meat analog composition may range from about 0.0001% to about 20% by weight of the composition. In another embodiment, the concentration of an antioxidant in a meat analog composition may range from about 0.001% to about 5% by weight of the composition. In yet another embodiment, the concentration of an antioxidant in a meat analog composition may range from about 0.01% to about I% by weight of the composition.

### B. Flavoring Agents

In an additional embodiment, the meat analog compositions may further comprise a flavoring agent such as an animal meat flavor, an animal meat oil, spice extracts, spice oils, natural smoke solutions, natural smoke extracts, yeast extract, and shiitake extract. Additional flavoring agents may include onion flavor, garlic flavor, or herb flavors. Herbs that may be added include basil, celery leaves, chervil, chives, cilantro, parsley, oregano, tarragon, and thyme. The meat analog composition may further comprise a flavor enhancer. Examples of flavor enhancers that may be used include salt (sodium chloride), glutamic acid salts (e.g., monosodium glutamate), glycine salts, guanylic acid salts, inosinic acid salts, 5′ribonucleotide salts, hydrolyzed proteins, and hydrolyzed vegetable proteins.

### C. Thickening Agents

In an additional embodiment, the meat analog compositions may further comprise a thickening or a gelling agent, such as alginic acid and its salts, agar, carrageenan and its salts, processed Eucheuma seaweed, gums (carob bean, guar, tragacanth, and xanthan), pectins, sodium carboxymethylcellulose, and modified starches.

### D. Vitamins and Minerals

In a further embodiment, the meat analog compositions may further comprise a nutrient such as a vitamin and/or a mineral. Suitable vitamins include Vitamins A, C, and E. Examples of minerals that may be added include the salts of aluminum, ammonium, calcium, magnesium, and potassium.

### VI. VARIETY OF FOOD APPLICATIONS

The meat analog compositions may be processed into a variety of food application for either human or animal consumption. By way of non-limiting example, the final product may be a meat analog composition for human consumption that simulates a chicken cutlet, ground meat product, a steak product, a sirloin tip product, a kebab product, a shredded product, a chunk meat product, a strip or a nugget product. Any of the foregoing products may be placed in a tray with overwrap, vacuum packed, retort canned or pouched, or frozen.

It is also envisioned that the meat analog compositions described herein may be utilized in a variety of animal diets, including diets of domestic pets. In one embodiment, the final product may be a meat analog composition formulated for companion animal consumption. In another embodiment, the final product may be a meat analog composition formulated for agricultural or zoo animal consumption. A skilled artisan can readily formulate the meat compositions for use in companion animal, agricultural animal or zoo animal diets.

### VII. EXAMPLES

### A. Extrusion Process

Soy protein isolate (Supro® 500E, Solae, St. Louis, Mo.), amaranth flour (Bakers Elements, Bolingbrook, Ill.), carrot fiber (Bolthouse Farms, Bakersfield, Calif.), canola oil (Associated Wholesale Grocers, Kansas City, Kans.), and vinegar (white distilled and diluted to 5% acidity, Hy-Vee, West Des Moines, Iowa) were used as ingredients. Except vinegar, the ingredients were blended with an 18.9 L Hobart Mixer (Hobart Corp., Troy, Ohio) for 30 min to ensure the uniformity of the feeding material.

Extrusion was performed using a pilot-scale, co-rotating, intermeshing, twin-screw food extruder (MPF 50/25, APV Baker Inc., Grand Rapids, Mich., U.S.A.) with a smooth barrel and a length-diameter ratio of 15:1. The clamshell style barrel is segmented into five temperature-controlled zones that are heated by an electric cartridge heating system and cooled with water. The barrel can be split horizontally and opened to enable rapid removal and cleaning of the barrel and the screws. The screws are built with screw elements and lobe-shaped paddles, which can be assembled on hexagon-shaped shafts to give different screw geometries. The screw profile is comprised of (from feed to exit): 100 mm, twin lead feed screw; 50 mm, 30° forwarding paddles; 100 mm, single lead screw; 87.5 mm, forwarding paddles; 175 mm, single lead screw; 87.5 mm, forwarding paddles; 50 mm, 30° reversing paddles; and 100 mm, single lead screw.

A continuous dry feeding loss-in-weight equipment (Model KMLT20, K-iron America, Pitman, N.J.) was used to feed the raw materials into the extruder. While operating, water at ambient temperature with or without vinegar was injected, via an inlet port, into the extruder by a positive displacement pump with a 12-mm head. The inlet port was located on the top of the barrel, 0.108 m downstream from the feeding port. The pump was pre-calibrated and adjusted so that the extrudate moisture content was 65%. The screw speed was set at 140 rpm. At the end of the extruder, a long cooling die was attached, with a dimension of 60 mm×10 mm×300 mm (W×H×L). Cold water (about 5° C.) was used as the cooling medium for the die. The extruder barrel temperatures were set at 25, 40, 95, 150, and 170° C. from the 1st (feeding zone) to the 5th zone, respectively.

### B. Analysis of the Meat Analog Compositions

The extruder responses, including die pressure, percent torque, and product temperature before the cooling die, were recorded.

A TA-HDi Texture Analyzer (Texture Technologies Corp., Scarsdale, N.Y.) with a Warner-Bratzler blade was used to measure the force that was required to shear the extrudate. A 5 kg load cell was used. A strip of extrudate, about 12-15 mm in width and 50 mm in length, was cut from samples parallel to the fiber lengthwise direction. The shearing action was perpendicular to the fiber orientation. The cross-head speed used was 1 mm/s. The peak force over sample cross-sectional area from 3 samples of each treatment was recorded and the average was recorded.

Digital images of extrudate directly from the extruder, about 20 cm in length, were taken for samples from each treatment. In addition, samples were dissected by hand, peeling along the direction of fiber orientation. The dissected samples were examined visually for the degree of fiber formation. Their black and white images, approximately 1.9 cm×1.4 cm (W×H) in size, were taken by a high-resolution camera attached to a computer and recorded digitally.

### C. Example 1

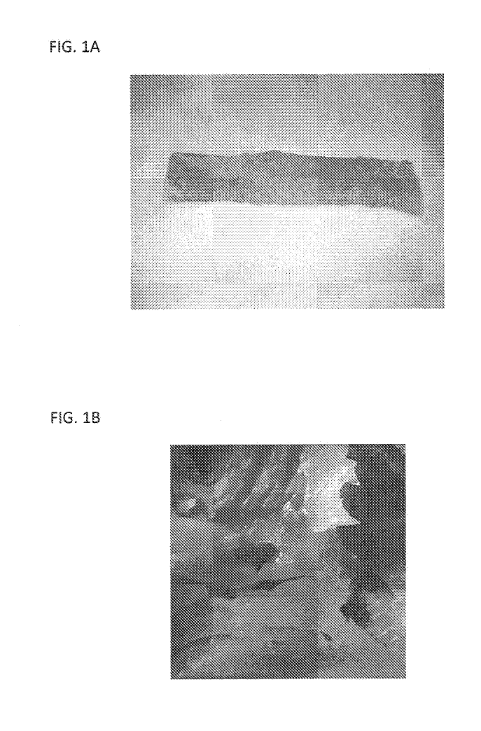

Soy protein isolate was metered into the feeding section of the APV Baker twin-screw extruder at a rate of 9.1 kg per hour. The water (pH 7.61) was injected so that a final extrudate had a moisture content of 65%. The product temperature was 142° C. before the cooling die and the die pressure was 196 psi. The torque was 15.9%. The product could not be peeled and had no fiber formation (FIG. 1). The average Warner-Bratzler shear force was 26.5 g/mm2.

### D. Example 2

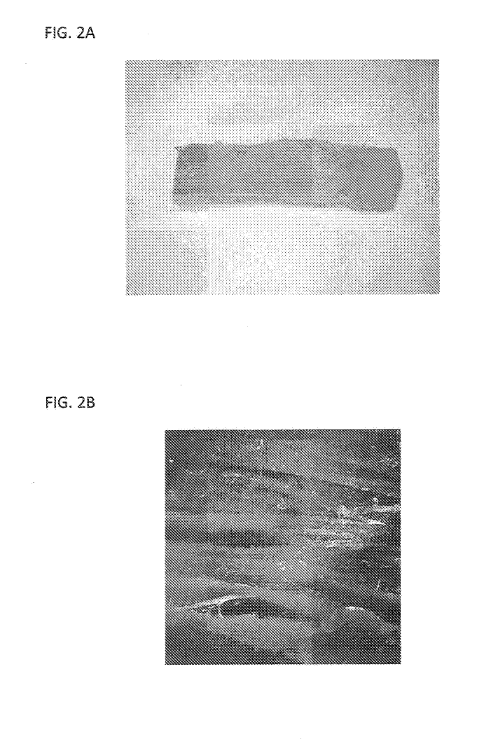

Soy protein isolate, amaranth flour, carrot fiber, and canola oil in 90.0:7.1:2.4:0.5 ratios was blended and metered into the feeding section of the APV Baker twin-screw extruder at a rate of 9.1 kg per hour. The water (pH 7.61) was injected so that a final extrudate had a moisture content of 65%. The product temperature was 143° C. before the cooling die and the die pressure was 80.9 psi. The torque was 12.0%. The peeled product had good fiber formation (FIG. 2). The average Warner-Bratzler shear force was 57.0 g/mm2.

### E. Example 3

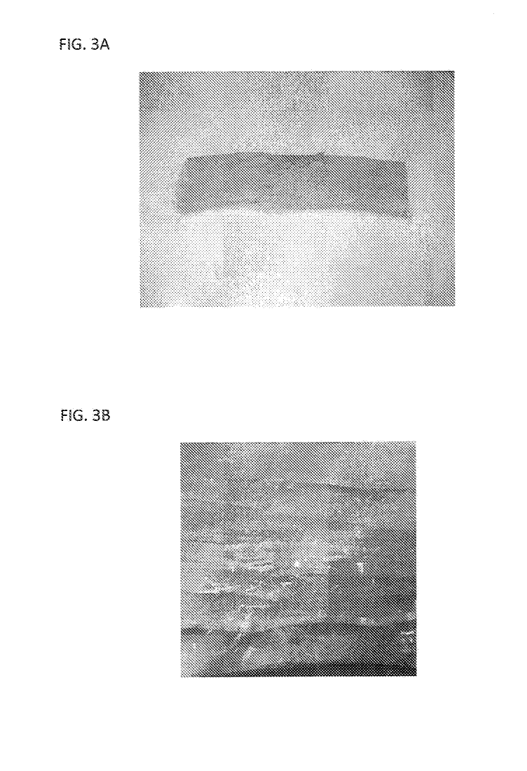

Soy protein isolate, amaranth flour, carrot fiber, and canola oil in 79:15:5:1 ratios was blended and metered into the feeding section of the APV Baker twin-screw extruder at a rate of 9.1 kg per hour. The water (pH 7.61) was injected so that a final extrudate had a moisture content of 65%. The product temperature was 139° C. before the cooling die and the die pressure was 63.0 psi. The torque was 11.1%. The peeled product had good fiber formation (FIG. 3). The average Warner-Bratzler shear force was 46.3 g/mm2.

### F. Example 4

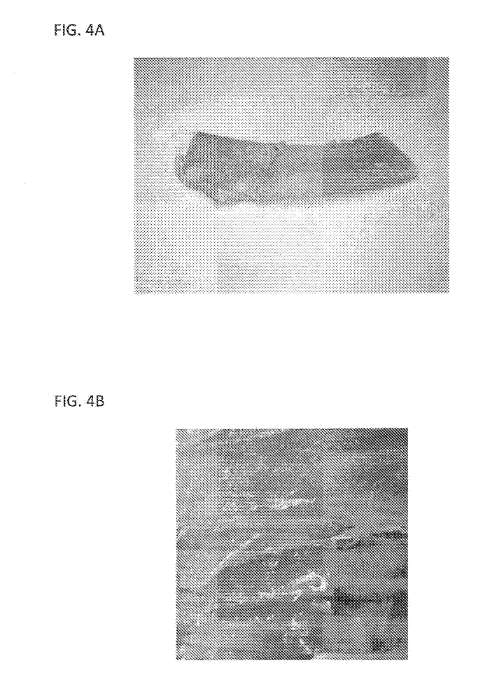

Soy protein isolate, amaranth flour, and carrot fiber in 79:15:5 ratios was blended and metered into the feeding section of the APV Baker twin-screw extruder at a rate of 9.1 kg per hour. The water (pH 7.61) was injected so that a final extrudate had a moisture content of 65%. The product temperature was 143° C. before the cooling die and the die pressure was 69.8 psi. The torque was 11.7%. The peeled product had good fiber formation (FIG. 4). The average Warner-Bratzler shear force was 54.5 g/mm2.

### G. Example 5

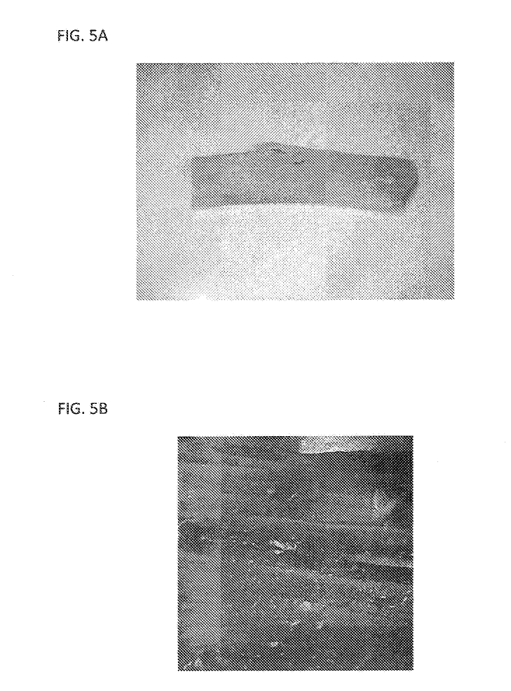

Soy protein isolate, amaranth flour, carrot fiber, and canola oil in 79:15:5:2 ratios was blended and metered into the feeding section of the APV Baker twin-screw extruder at a rate of 9.1 kg per hour. The water (pH 7.61) was injected so that a final extrudate had a moisture content of 65%. The product temperature was 143° C. before the cooling die and the die pressure was 67.4 psi. The torque was 11.1%. The peeled product had good fiber formation (FIG. 5). The average Warner-Bratzler shear force was 47.5 g/mm2.

### H. Example 6

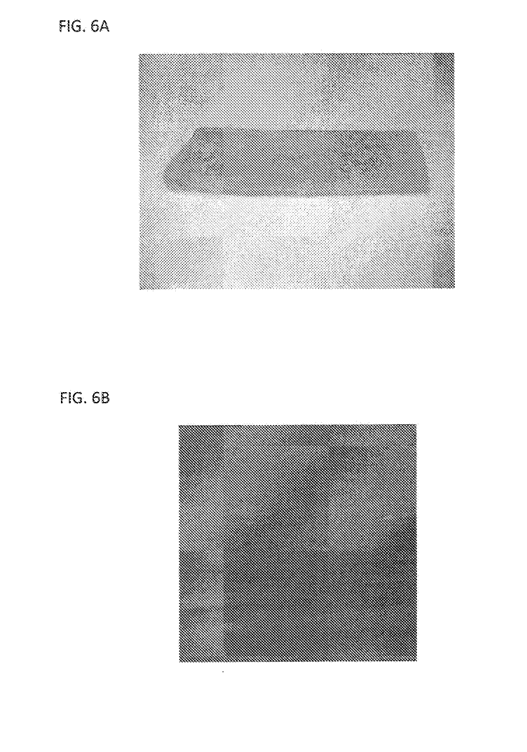

Soy protein isolate, amaranth flour, carrot fiber, and canola oil in 79:15:5:3 ratios was blended and metered into the feeding section of the APV Baker twin-screw extruder at a rate of 9.1 kg per hour. The water (pH 7.61) was injected so that a final extrudate had a moisture content of 65%. The product temperature was 140° C. before the cooling die and the die pressure was 59.5 psi. The torque was 10.7%. The peeled product had good fiber formation (FIG. 6). The average Warner-Bratzler shear force was 46.3 g/mm2.

### I. Example 7

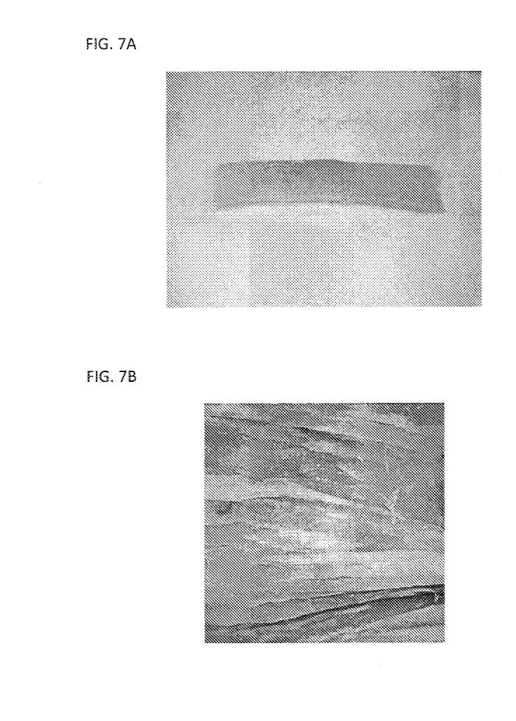

Soy protein isolate, amaranth flour, carrot fiber, and canola oil in 79:15:5:1 ratios was blended and metered into the feeding section of the APV Baker twin-screw extruder at a rate of 9.1 kg per hour. The water containing 0.5% vinegar by volume (pH 6.11) was injected so that a final extrudate had a moisture content of 65%. The product temperature was 140° C. before the cooling die and the die pressure was 59.3 psi. The torque was 11.3%. The peeled product had good fiber formation (FIG. 7). The average Warner-Bratzler shear force was 43.8 g/mm2.

### J. Example 8

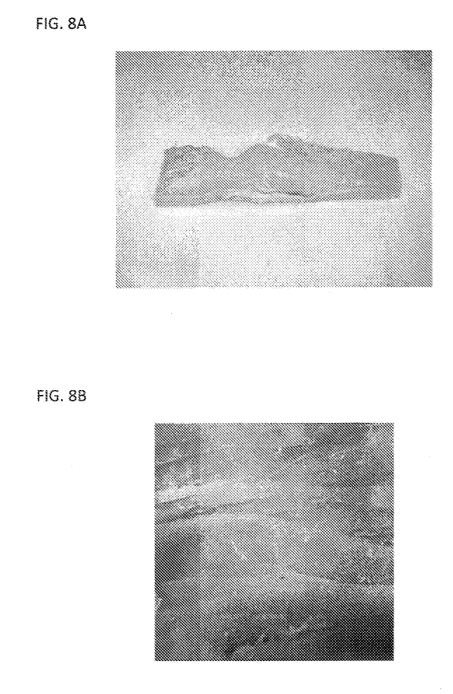

Soy protein isolate, amaranth flour, carrot fiber, and canola oil in 79:15:5:1 ratios was blended and metered into the feeding section of the APV Baker twin-screw extruder at a rate of 9.1 kg per hour. The water containing 1.0% vinegar by volume (pH 5.24) was injected so that a final extrudate had a moisture content of 65%. The product temperature was 140° C. before the cooling die and the die pressure was 62.9 psi. The torque was 11.2%. The product had good fiber formation (FIG. 8). The average Warner-Bratzler shear force was 41.6 g/mm2.

### K. Comparison

Table 1 shows the effect of percent edible lipid material (canola oil in this case) in dry mix on product temperature, percent torque, die pressure, and shear force. Adding canola oil at a level as low as 1% reduced the shear force. Both percent torque and die pressure became lower when increasing oil from 0 to 3% level.

TABLE 1
Effect of oil concentration on certain parameters

Oil (%)

| | 0% | 1% | 2% | 3% |
|---|---|---|---|---|
| Product Temp. (° C.) | 143 | 139 | 143 | 140 |
| Torque (%) | 11.7 | 11.1 | 11.1 | 10.7 |
| Die Pressure (psi) | 69.8 | 63.0 | 67.4 | 59.5 |
| Average Warner- | 54.5 | 46.3 | 47.5 | 46.3 |
| Bratzler shear force | | | | |

Table 2 shows the effect of percent protein in dry mix on product temperature, % torque, die pressure and shear force. Both percent torque and die pressure showed significant reduction when decreasing the protein content in the dry mix from 100% to 79%. The extrudate shear force was also reduced when decreasing the protein content from 90 to 79%. It is believed that the low shear force at 100% protein was most likely due to lack of fiber formation.

TABLE 2
Effect of protein concentration on certain parameters

| | Protein in dry mix(%) | | |
|---|---|---|---|
| | 100% | 90% | 79% |
| Product Temp. (° C.) | 142 | 143 | 139 |
| Torque (%) | 15.9 | 12.0 | 11.1 |
| Die Pressure (psi) | 196 | 80.9 | 63.0 |
| Average Warner-Bratzler | 26.5 | 57.0 | 46.3 |
| shear force (g/mm²) | | | |

What is claimed is:

1. A structured plant protein product comprising protein fibers that are substantially aligned, wherein the protein fibers comprise:
(a) dry ingredients that comprise:
(i) a protein component that comprises a plant-derived protein material, wherein the protein component is at an amount that is no more than about 90% by weight of the dry ingredients;
(ii) a carbohydrate component at an amount that is in the range of about 2 to about 50% by weight of the dry ingredients; and
(iii) a lipid component at an amount that is in the range of about 0.1 to about 5% by weight of the dry ingredients; and
(b) wet ingredients that comprise water; and
wherein the structured plant protein product has a moisture content that is at least about 50% by weight of the structured plant protein product.

2. The structured plant protein product of claim 1, wherein:
the amount of the protein component is in the range of about 40 to about 90% by weight of the dry ingredients;
the amount of the carbohydrate component is in the range of about 5 to about 30% by weight of the dry ingredients;
the moisture content of the structured plant protein product is in the range of about 50 to about 75% of the structured plant protein product; and
at least about 55% of the protein fibers are contiguous to each other at less than approximately a 45° angle when viewed in a horizontal plane.

3. The structured plant protein product of claim 1, wherein:
the amount of the protein component is in the range of about 50 to about 90% by weight of the dry ingredients;
the amount of the carbohydrate component is in the range of about 10 to about 20% by weight of the dry ingredients;
the amount of the lipid component is in the range of about 1 to about 3% by weight of the dry ingredients;
the moisture content of the structured plant protein product is in the range of about 55 to about 70% of the structured plant protein product; and
at least about 75% of the protein fibers are contiguous to each other at less than approximately a 45° angle when viewed in a horizontal plane.

4. The structured plant protein product of claim 1, wherein:
the amount of the protein component is in the range of about 60 to about 90% by weight of the dry ingredients;
the amount of the carbohydrate component is in the range of about 10 to about 20% by weight of the dry ingredients;
the amount of the lipid component is in the range of about 1 to about 3% by weight of the dry ingredients;
the moisture content of the structured plant protein product is in the range of about 60 to about 65% of the structured plant protein product; and
at least about 90% of the protein fibers are contiguous to each other at less than approximately a 45° angle when viewed in a horizontal plane.

5. The structured plant protein product of claim 1 having an average Warner-Bratzler shear force that is less than 60 g/mm².

6. The structured plant protein product of claim 1 having an average Warner-Bratzler shear force that is in the range of about 25 to about 50 g/mm².

7. The structured plant protein product of claim 1 having an average Warner-Bratzler shear force that is in the range of about 30 to about 40 g/mm².

8. The structured plant protein product of claim 1, wherein the protein component further comprises an animal-derived protein material that is selected from the group consisting of casein, caseinates, whey protein, milk protein concentrate, milk protein isolate, ovalbumin, ovoglobulin, ovomucin, ovomucoid, ovotransferrin, ovovitella, ovovitellin, albumin globulin, vitellin, and combinations thereof.

9. The structured plant protein product of claim 1, wherein the lipid component is selected from a plant-derived lipid material, an animal-derived lipid material, and combinations thereof.

10. The structured plant protein product of claim 1, wherein:
the protein component consists of the plant-derived protein material; and
the lipid component consists of a plant-derived lipid material.

11. The structured plant protein product of claim 10, wherein:
the plant-derived protein material is selected from the group consisting of protein derived soybeans, corn, peas, canola, sunflowers, sorghum, rice, amaranth, potato, tapioca, arrowroot, canna, lupin, rape, wheat, oats, rye, barley, and combinations thereof;
the plant-derived lipid material is selected from the group consisting of canola oil, soybean oil, cottonseed oil, peanut oil, palm oil, corn oil, and combinations thereof.

12. The structured plant protein product of claim 10, wherein:
the plant-derived protein material is one or more soy protein materials; and
the plant-derived lipid material is canola oil.

13. The structured plant protein product of claim 1, wherein the carbohydrate component is selected from the group consisting of flour, starch, edible fiber, and combinations thereof.

14. The structured plant protein product of claim 13, wherein:
the flour is selected from the group consisting of wheat flour, rice flour, white corn flour, oat flour, sorghum flour, rye flour, potato flour, amaranth flour, quinoa flour, and combinations thereof;
the starch is selected from the group consisting of wheat starch, corn starch, rice starch, oat starch, potato starch, and combinations thereof; and
the edible fiber is selected from the group consisting of wood pulp cellulose, modified cellulose, seed husks, oat hulls, citrus fiber, carrot fiber, pea fiber, corn bran, soy polysaccharide, oat bran, wheat bran, barley bran, rice bran, and combinations thereof.

15. The structured plant protein product of claim 13, wherein the carbohydrate component is amaranth flour and carrot fiber.

16. The structured plant protein product of claim 13, wherein the carbohydrate component comprises edible fiber at an amount that is in the range of about 0.1 to about 10% by weight of the dry ingredients.

17. The structured plant protein product of claim 13, wherein the carbohydrate component comprises edible fiber at an amount that is in the range of about 2 to about 8% by weight of the dry ingredients.

18. The structured plant protein product of claim 1, wherein the wet ingredients further comprise a pH-lowering agent such that the wet ingredients has a pH that is below approximately 7.0.

19. The structured plant protein product of claim 18, wherein the pH-lowering agent is a food grade acid selected from the group consisting of acetic acid, lactic acid, hydrochloric acid, phosphoric acid, citric acid, tartaric acid, malic acid, and combinations thereof.

20. The structured plant protein product of claim 1, wherein the wet ingredients further comprises a pH-lowering agent such that the wet ingredients has a pH that is below approximately 6.0.

21. The structured plant protein product of claim 1, wherein the wet ingredients further comprise a pH-lowering agent such that the wet ingredients has a pH below approximately 5.0.

22. A structured plant protein product comprising protein fibers, wherein at least about 90% of the protein fibers are contiguous to each other at less than approximately a 45° angle when viewed in a horizontal plane, and wherein the protein fibers comprise:
(a) dry ingredients that comprise:
(i) a plant-derived protein material, wherein the plant-derived protein material is at an amount that is in the range of about 60 to about 90% by weight of the dry ingredients;
(ii) a carbohydrate component at an amount that is in the range of about 10 to about 30% by weight of the dry ingredients, wherein the carbohydrate components comprises edible fiber material at an amount that is in the range of about 2 to about 8% by weight of the dry ingredients; and
(iii) an plant-derived lipid material an at an amount that is in the range of about 1 to about 5% by weight of the dry ingredients; and
(b) wet ingredients that comprise water; and
wherein the structured plant protein product has a moisture content that at least about 50% by weight of the structure plant protein product and an average Warner-Bratzler shear force that is less than 60 g/mm².

23. The structured plant protein product of claim 22, wherein:
the plant-derived protein material is one or more soy protein materials;
the plant-derived lipid material is canola oil;
the edible fiber is carrot fiber; and
the carbohydrate component further comprises amaranth flour.

24. A process for making a structured plant protein product, the process comprising extruding a mixture under conditions of elevated temperature and pressure to form the structured plant protein product, wherein the structured plant protein product comprises protein fibers that are substantially aligned, and wherein the structured plant protein product has a moisture content that is at least about 50% by weight of the structured plant protein product, and wherein the mixture comprises:
(a) dry ingredients that comprise:
(i) a protein component that comprises a plant-derived protein material, wherein the protein component is at an amount that is no more than about 90% by weight of the dry ingredients;
(ii) a carbohydrate component at an amount that is in the range of about 2 to about 50% by weight of the dry ingredients; and
(iii) a lipid component at an amount that is in the range of about 0.1 to about 5% by weight of the dry ingredients; and
(b) wet ingredients that comprise water.

25. The process of claim 24, wherein the elevated temperature of the extrusion is in the range of about 140 to about 180° C. and the elevated pressure of the extrusion is in the range of about 50 to about 500 psig.

26. The process of claim 24, wherein:
the amount of the protein component is in the range of about 40 to about 90% by weight of the dry ingredients;
the amount of the carbohydrate component is in the range of about 5 to about 30% by weight of the dry ingredients;
the moisture content of the structured plant protein product is in the range of about 50 to about 75% of the structured plant protein product;
at least about 55% of the protein fibers are contiguous to each other at less than approximately a 45° angle when viewed in a horizontal plane; and
the structure plant protein product has an average Warner-Bratzler shear force that is less than 60 g/mm².

27. The process of claim 24, wherein:
the amount of the protein component is in the range of about 60 to about 90% by weight of the dry ingredients;
the amount of the carbohydrate component is in the range of about 10 to about 20% by weight of the dry ingredients;
the amount of the lipid component is in the range of about 1 to about 3% by weight of the dry ingredients;
the moisture content of the structured plant protein product is in the range of about 60 to about 65% of the structured plant protein product;
at least about 90% of the protein fibers are contiguous to each other at less than approximately a 45° angle when viewed in a horizontal plane; and
the structured plant protein product has an average Warner-Bratzler shear force that is in the range of about 25 to about 50 g/mm².

28. The process of claim 24, wherein the protein component further comprises an animal-derived protein material.

29. The process of claim 24, wherein the lipid component is selected from a plant-derived lipid material, an animal-derived lipid material, and combinations thereof.

30. The process of claim 24, wherein:
the protein component consists of the plant-derived protein material; and
the lipid component consists of a plant-derived lipid material.

31. The process of claim 24, wherein the carbohydrate component comprises flour and edible fiber.

32. The process of claim 31, wherein the edible fiber is at an amount that is in the range of about 0.1 to about 10% by weight of the dry ingredients.

33. A meat analog composition comprising a structured plant protein product, wherein the structured plant protein product comprises protein fibers that are substantially aligned, wherein the protein fibers comprise:
(a) dry ingredients that comprise:
(i) a protein component that comprises a plant-derived protein material, wherein the protein component is at an amount that is no more than about 90% by weight of the dry ingredients;
(ii) a carbohydrate component at an amount that is in the range of about 2 to about 50% by weight of the dry ingredients; and
(iii) a lipid component at an amount that is in the range of about 0.1 to about 5% by weight of the dry ingredients; and
(b) wet ingredients that comprise water; and
wherein the structured plant protein product has a moisture content that is at least about 50% by weight of the structured plant protein product.

34. The meat analog composition of claim 33, further comprising animal meat.

35. The meat analog composition of claim 33, wherein:
the amount of the protein component is in the range of about 60 to about 90% by weight of the dry ingredients and the protein component is plant-derived protein material;
the amount of the carbohydrate component is in the range of about 10 to about 20% by weight of the dry ingredients and the carbohydrate component comprises flour and edible fiber, wherein the edible fiber is at an amount that is in the range of about 0.1 to about 10% by weight of the dry ingredients;
the amount of the lipid component is in the range of about 1 to about 3% by weight of the dry ingredients and the lipid component is plant-derived lipid material;
the moisture content of the structured plant protein product is in the range of about 60 to about 65% of the structured plant protein product;
at least about 90% of the protein fibers are contiguous to each other at less than approximately a 45° angle when viewed in a horizontal plane; and
the structured plant protein product has an average Warner-Bratzler shear force that is in the range of about 25 to about 50 g/mm².

36. A food application comprising a meat analog composition that comprises a structured plant protein product, wherein the structured plant protein product comprises protein fibers that are substantially aligned, wherein the protein fibers comprise:
(a) dry ingredients that comprise:
(i) a protein component that comprises a plant-derived protein material, wherein the protein component is at an amount that is no more than about 90% by weight of the dry ingredients;
(ii) a carbohydrate component at an amount that is in the range of about 2 to about 50% by weight of the dry ingredients; and
(iii) a lipid component at an amount that is in the range of about 0.1 to about 5% by weight of the dry ingredients; and
(b) wet ingredients that comprise water; and
wherein the structured plant protein product has a moisture content that is at least about 50% by weight of the structured plant protein product.

37. The food application of claim 36, wherein:
the amount of the protein component is in the range of about 60 to about 90% by weight of the dry ingredients and the protein component is plant-derived protein material;
the amount of the carbohydrate component is in the range of about 10 to about 20% by weight of the dry ingredients and the carbohydrate component comprises flour and edible fiber, wherein the edible fiber is at an amount that is in the range of about 0.1 to about 10% by weight of the dry ingredients;
the amount of the lipid component is in the range of about 1 to about 3% by weight of the dry ingredients and the lipid component is plant-derived lipid material;
the moisture content of the structured plant protein product is in the range of about 60 to about 65% of the structured plant protein product;
at least about 90% of the protein fibers are contiguous to each other at less than approximately a 45° angle when viewed in a horizontal plane; and
the structured plant protein product has an average Warner-Bratzler shear force that is in the range of about 25 to about 50 g/mm².
